(19) United States
(12) Patent Application Publication
(10) Pub. No.: US 2011/0162789 A1
(43) Pub. Date: Jul. 7, 2011

(54) TRANSFER PAPER FOR PRINTING, METHOD OF MANUFACTURING THE SAME AND PRINTING METHOD USING THE SAME

(76) Inventor: Jin Hwan LEE, Incheon (KR)

(21) Appl. No.: 12/718,515

(22) Filed: Mar. 5, 2010

(30) Foreign Application Priority Data
Jan. 6, 2010 (KR) 10-2010-0000864

(51) Int. Cl. B44C 1/16; B41M 5/40; B05D 1/36

(52) U.S. Cl. 156/230; 428/32.83; 427/152

(57) ABSTRACT

This invention relates to transfer paper for printing, a method of manufacturing the same and a printing method using the same. The transfer paper is manufactured by applying a wax solution including 98.5 wt % of wax, 1 wt % of a lipophilic dispersant including GPG, and 0.5 wt % of an emulsifier including C-5 and being melted at 150˜200° C., onto a base film, thus forming a wax layer, which is then primarily coated with a first thickener composition including 50 wt % of water at 70˜80° C., 39 wt % of dextrin, 3 wt % of titanium dioxide including R902, 2.5 wt % of a lipophilic dispersant including GPG, 5 wt % of an absorbent including HDK, and 0.5 wt % of an anti-reducing agent, thus forming a first thickener layer, which is then secondarily coated with a second thickener composition including 15 wt % of polyvinylalcohol including P17 and water at 90˜100° C., thus facilitating the coating process for applying the thickener to a high density and making coating surface smoothness uniform, thereby increasing ink absorptivity and ensuring deep dyeing and good level dyeing, resulting in a clean image. In the second thickener composition, polyvinylalcohol having high absorptivity of ink and water prevents spreading of the dye solution and the separation of the thickener applied to an appropriate thickness.

### BACKGROUND OF THE INVENTION

1. Technical Field

The present invention relates to a method of manufacturing transfer paper for printing, and particularly to transfer paper for printing, which is suitable for use in transferring a pattern onto cloth through digital printing so that deep dyeing is obtained and good level dyeing is ensured resulting in a clean image, and to a method of manufacturing the same.

2. Description of the Related Art

Typically used in transfer printing treatment of cloth, transfer paper is coated with wax and a thickener, and has a pattern formed thereon so as to show figures, markings or color changes. Such a pattern is determined in consideration of the number of color printing processes on wax paper. The pattern is formed through digital printing, thus enabling formation of a very fine pattern. Furthermore, a dye is not directly printed on cloth but is adsorbed only to hydrophilic portions of the wax and thickener layers of the transfer paper and thus transferred, thus enabling the dyeing of a very fine pattern.

After the formation of the pattern on the transfer paper, dye and auxiliaries fed from at least one dye solution tank by means of a dye solution feeder are mixed. The mixture of dye and auxiliaries may be applied on the transfer paper using a spraying process or a showering process, preferably gravure printing, silk screen printing or offset printing.

The transfer paper on which the pattern is formed and the mixture of dye and auxiliaries is applied is introduced into a pressing device, and also cloth subjected to dipping treatment depending on printing conditions is conveyed in the device using a conveying roller. Subsequently, the transfer paper and the cloth are pressed under conditions of predetermined pressure and temperature, so that the pattern is transferred onto the cloth from the transfer paper. Subsequently, the cloth having the pattern is aged, washed with water, dewatered and dried.

In the transfer printing method as above, when the transfer paper coated with the wax layer and the thickener layer is manufactured, workability and coating surface smoothness which affects ink absorptivity may vary depending on the coating smoothness of the wax and thickener layers and the applied amounts thereof. Moreover, the problems related to the sense of touch of the pattern transferred onto the cloth from the transfer paper being reduced and the thickener being separated from the cloth upon water washing and dewatering may occur.

As the applied amount of the thickener of the coating surface layer is increased, warping of the transfer paper is reduced and the transfer rate is increased upon deep dyeing, but the surface becomes rough.

### SUMMARY OF THE INVENTION

Accordingly, the present invention has been made keeping in mind the problems regarding coating of transfer paper with a thickener encountered in the related art and the present invention is intended to provide a method of manufacturing transfer paper for printing, which improves coating workability of transfer paper with a thickener and uniformly improves coating surface smoothness, so that deep dyeing is obtained and good ink absorptivity and level dyeing are ensured, resulting in a clean image.

Also the present invention is intended to provide a printing method of dyeing a pattern on cloth using transfer paper according to the present invention.

An aspect of the present invention provides transfer paper for printing, on which a pattern to be transferred will be formed, including a base film, a wax layer formed on the base film and composed of 98.5 wt % of wax, 1 wt % of a lipophilic dispersant including GPG, and 0.5 wt % of an emulsifier including C-5, a first thickener layer formed on the wax layer and composed of 50 wt % of water at 70˜80° C., 39 wt % of dextrin, 3 wt % of titanium dioxide including R902, 2.5 wt % of a lipophilic dispersant including GPG, 5 wt % of an absorbent including HDK, and 0.5 wt % of an anti-reducing agent, which are homogeneously mixed, and a second thickener layer formed on the first thickener layer and composed of 15 wt % of polyvinylalcohol including P17 and 85 wt % of water at 90˜100° C., which are homogeneously mixed using a mixer.

Another aspect of the present invention provides a method of manufacturing the transfer paper for printing, including applying a wax solution, composed of 98.5 wt % of wax, 1 wt % of a lipophilic dispersant including GPG, and 0.5 wt % of an emulsifier including C-5 and melted at 150˜200° C., onto a base film for transfer paper from a wax solution box using 150-mesh rollers, thus forming a wax layer, primarily coating the wax layer with a first thickener composition composed of 50 wt % of water at 70˜80° C., 39 wt % of dextrin, 3 wt % of titanium dioxide including R902, 2.5 wt % of a lipophilic dispersant including GPG, 5 wt % of an absorbent including HDK, and 0.5 wt % of an anti-reducing agent, which are homogeneously mixed using a mixer, thus forming a first thickener layer, and secondarily coating the first thickener layer with a second thickener composition composed of 15 wt % of polyvinylalcohol including P17 and 85 wt % of water at 90˜100° C., which are homogeneously mixed using a mixer.

In this aspect, primarily coating the wax layer with the first thickener composition may be performed using two 120-mesh rollers, and secondarily coating the first thickener layer with the second thickener composition may be performed using 130-mesh rollers.

A further aspect of the present invention provides a printing method, including manufacturing transfer paper by applying a wax solution, composed of 98.5 wt % of wax, 1 wt % of a lipophilic dispersant including GPG, and 0.5 wt % of an emulsifier including C-5 and melted at 150˜200° C., onto a base film for transfer paper from a wax solution box using 150-mesh rollers, thus forming a wax layer, primarily coating the wax layer with a first thickener composition composed of 50 wt % of water at 70˜80° C., 39 wt % of dextrin, 3 wt % of titanium dioxide including R902, 2.5 wt % of a lipophilic dispersant including GPG, 5 wt % of an absorbent including HDK, and 0.5 wt % of an anti-reducing agent, which are homogeneously mixed using a mixer, thus forming a first thickener layer, and secondarily coating the first thickener layer with a second thickener composition composed of 15 wt % of polyvinylalcohol including P17 and 85 wt % of water at 90˜100° C., which are homogeneously mixed using a mixer, forming a predetermined pattern on the transfer paper, hot pressing the transfer paper having the predetermined pattern and cloth using a press so that the predetermined pattern of the transfer paper is transferred onto the cloth, and subjecting the cloth having the predetermined pattern transferred thereon to a series of processes including aging, water washing, dewatering and drying.

### DESCRIPTION OF SPECIFIC EMBODIMENTS

Hereinafter, embodiments of the present invention will be described in detail.

According to the present invention, transfer paper for printing includes a base film, a wax layer formed on the base film and composed of 98.5 wt % of wax, 1 wt % of a lipophilic dispersant such as GPG and 0.5 wt % of an emulsifier such as C-5, a first thickener layer formed on the wax layer and composed of 50 wt % of water at 70˜80° C., 39 wt % of dextrin, 3 wt % of titanium dioxide such as R902, 2.5 wt % of a lipophilic dispersant such as GPG, 5 wt % of an absorbent such as HDK and 0.5 wt % of an anti-reducing agent, which are homogeneously mixed, and a second thickener layer formed on the first thickener layer and composed of 15 wt % of polyvinylalcohol (PVA) such as P17 and 85 wt % of water at 90˜100° C., which are homogeneously mixed using a mixer.

The transfer paper for printing according to the present invention is manufactured through the following procedures.

Specifically, a wax solution is applied onto a base film for transfer paper from a wax solution box using 150-mesh rollers, thus forming a wax layer. As such, the wax solution may be prepared by homogeneously mixing wax and auxiliaries using a mixer, the wax solution being composed of 98.5 wt % of wax, 1 wt % of a lipophilic dispersant such as GPG, and 0.5 wt % of an emulsifier such as C-5, and being melted at 150˜200° C.

Subsequently, the wax layer is coated with a thickener through primary coating and secondary coating. A first thickener composition used in the primary coating may include 50 wt % of water at 70˜80° C., 39 wt % of dextrin, 3 wt % of titanium dioxide such as R902, 2.5 wt % of a lipophilic dispersant such as GPG, 5 wt % of an absorbent such as HDK, and 0.5 wt % of an anti-reducing agent, which are homogeneously mixed using a mixer and then balled three times using a balling machine.

Also, a second thickener composition used in the secondary coating may include 15 wt % of PVA such as P17 and 85 wt % of water at 90˜100° C., which are homogeneously mixed using a mixer. Such a second thickener composition may be cooled to room temperature and then diluted with water at a weight ratio of 60:40 depending on the viscosity required upon use.

The primary coating may be carried out by applying the first thickener composition using two 120-mesh rollers, and the secondary coating may be carried out by applying the second thickener composition using 130-mesh rollers.

The PVA of the secondary thickener composition has high absorptivity of ink or water and advantageously prevents the spreading and is superior in terms of showing a fine pattern consisting of thin lines. Also, the PVA forms a film on the transfer paper and thus maintains the humidity at appropriate level even under humid conditions such as a rainy day, thus preventing the deformation of transfer paper. However, as the thickness of the second thickener layer is increased, the force of adhesion is enhanced, and thus the thickener after transfer of ink is not removed upon a water washing process after a transfer process but remains as a thin layer, undesirably reducing the tactile sense of the cloth. Furthermore, after a pressing process, the force of attaching the paper to the cloth is enhanced, undesirably deteriorating the workability.

In addition, the process of manufacturing the transfer paper as above is followed by performing a series of processes, including forming a required pattern on the transfer paper using digital printing, hot pressing the transfer paper having the pattern and the dipped cloth using a press so that the pattern of the transfer paper is transferred onto the cloth, aging the cloth having the pattern transferred thereon so as to fix the dye thereon, washing the cloth with water to remove the thickener and the dye solution, and dewatering and drying the cloth which is wet through water washing.

As described hereinbefore, the present invention provides transfer paper for printing, a method of manufacturing the same and a printing method using the same. According to the present invention, the transfer paper includes a first thickener layer resulting from primary coating of a first thickener composition using two 120-mesh rollers, and a second thickener layer resulting from secondary coating of a second thickener composition using 130-mesh rollers, thus facilitating the coating process for applying the thickener to a high density and making the coating surface smoothness uniform, and therefore, upon cloth printing, ink absorptivity is increased, and deep dyeing and good level dyeing are obtained, resulting in a clean image. In the second thickener composition, PVA has high absorptivity of ink and water, and thus prevents the spreading of the dye solution and the separation of the thickener which is applied to an appropriate thickness.

Also, according to the present invention, the transfer paper is suitable for use in transfer printing of a clear and fine pattern onto cloth so as to make the workability stable and improve quality of cloth.

Although the embodiments of the present invention have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A transfer paper for printing, on which a pattern to be transferred will be formed, comprising:
a base film;
a wax layer formed on the base film and comprising 98.5 wt % of wax, 1 wt % of a lipophilic dispersant including GPG, and 0.5 wt % of an emulsifier including C-5;
a first thickener layer formed on the wax layer and comprising 50 wt % of water at 70˜80° C., 39 wt % of dextrin, 3 wt % of titanium dioxide including R902, 2.5 wt % of a lipophilic dispersant including GPG, 5 wt % of an absorbent including HDK, and 0.5 wt % of an anti-reducing agent, which are homogeneously mixed; and
a second thickener layer formed on the first thickener layer and comprising 15 wt % of polyvinylalcohol including P17 and 85 wt % of water at 90˜100° C., which are homogeneously mixed using a mixer.

2. A method of manufacturing a transfer paper for printing, comprising:
applying a wax solution, which comprises 98.5 wt % of wax, 1 wt % of a lipophilic dispersant including GPG, and 0.5 wt % of an emulsifier including C-5 and which is melted at 150˜200° C., onto a base film for transfer paper from a wax solution box using 150-mesh rollers, thus forming a wax layer;
primarily coating the wax layer with a first thickener composition comprising 50 wt % of water at 70˜80° C., 39 wt % of dextrin, 3 wt % of titanium dioxide including R902, 2.5 wt % of a lipophilic dispersant including GPG, 5 wt % of an absorbent including HDK, and 0.5 wt % of an anti-reducing agent, which are homogeneously mixed using a mixer, thus forming a first thickener layer; and
secondarily coating the first thickener layer with a second thickener composition comprising 15 wt % of polyvinylalcohol including P17 and 85 wt % of water at 90˜100° C., which are homogeneously mixed using a mixer.

3. The method as set forth in claim 2, wherein the primarily coating the wax layer with the first thickener composition is performed using two 120-mesh rollers, and the secondarily coating the first thickener layer with the second thickener composition is performed using 130-mesh rollers.

4. A printing method, comprising:
manufacturing a transfer paper by applying a wax solution, which comprises 98.5 wt % of wax, 1 wt % of a lipophilic dispersant including GPG, and 0.5 wt % of an emulsifier including C-5 and which is melted at 150˜200° C., onto a base film for transfer paper from a wax solution box using 150-mesh rollers, thus forming a wax layer, primarily coating the wax layer with a first thickener composition comprising 50 wt % of water at 70˜80° C., 39 wt % of dextrin, 3 wt % of titanium dioxide including R902, 2.5 wt % of a lipophilic dispersant including GPG, 5 wt % of an absorbent including HDK, and 0.5 wt % of an anti-reducing agent, which are homogeneously mixed using a mixer, thus forming a first thickener layer, and secondarily coating the first thickener layer with a second thickener composition comprising 15 wt % of polyvinylalcohol including P17 and 85 wt % of water at 90˜100° C., which are homogeneously mixed using a mixer;
forming a predetermined pattern on the transfer paper;
hot pressing the transfer paper having the predetermined pattern and cloth using a press so that the predetermined pattern of the transfer paper is transferred onto the cloth; and
subjecting the cloth having the predetermined pattern transferred thereon to a series of processes including aging, water washing, dewatering and drying.
